(19) United States
(12) Patent Application Publication
(10) Pub. No.: US 2019/0200431 A1
(43) Pub. Date: Jun. 27, 2019

(54) DRIVE DEVICE

(71) Applicants: AutoNetworks Technologies, Ltd., Yokkaichi, Mie (JP); Sumitomo Wiring Systems, Ltd., Yokkaichi, Mie (JP); Sumitomo Electric Industries, Ltd., Osaka (JP)

(72) Inventor: Junpei HORII, Yokkaichi, Mie (JP)

(21) Appl. No.: 16/311,400

(22) PCT Filed: Jun. 27, 2017
(86) PCT No.: PCT/JP2017/023560

§ 371 Date: Dec. 19, 2018

(30) Foreign Application Priority Data
Jul. 4, 2016 (JP) 2016-132600

(51) Int. Cl. H05B 37/02; H05B 39/04; H05B 33/08

(52) U.S. Cl. CPC H05B 37/0209; H05B 33/0845; H05B 39/041

(57) ABSTRACT

In a drive device, a drive circuit drives light-emitting diodes by alternately switching a switch on and off. A voltage detection unit detects a battery voltage value at a positive terminal of a battery. A control unit calculates a duty on the basis of the value detected by the voltage detection unit and changes a duty for switching the switch on and off to the calculated duty. If the battery voltage value is the value detected by the voltage detection unit, when the switch is on, the duty calculated by the control unit is the ratio of a target current value to the value of current flowing in the light-emitting diodes.

### CROSS-REFERENCE TO RELATED APPLICATIONS

This application is the U.S. national stage of PCT/JP2017/023560 filed Jun. 27, 2017, which claims priority of Japanese Patent Application No. JP 2016-132600 filed Jul. 4, 2016.

### TECHNICAL FIELD

The present disclosure relates to a drive device.

### BACKGROUND

JP 2003-338396A discloses a drive device that drives an incandescent light bulb. In this drive device, one end of the switch is connected to a power supply source, and the incandescent light bulb is disposed in a current path of current flowing from the other end of the switch. The incandescent light bulb is driven by switching the switch on and off in an alternating manner. The drive device according to JP 2003-338396A detects the value of voltage output by the power supply source.

A duty, which is the ratio of a target power value to the value of power consumed in the case where the value of the voltage output by the power supply source is a detection value and the switch is on, is calculated. The duty for switching the switch on and off is changed to the calculated duty. The average value of the power consumed by the incandescent light bulb therefore stabilizes at the target power value, regardless of the value of the voltage output by the power supply source. This prevents the incandescent light bulb from flickering.

Light-emitting diodes are becoming widespread as light-emitting units installed in vehicles. The intensity of the light emitted by a light-emitting diode fluctuates depending on the average value of current supplied to the light-emitting diode. When the average value of the current supplied to a light-emitting diode is stable, the intensity of the light emitted by the light-emitting diode stabilizes as well. The average value of the current is a value averaged over a finite constant period.

If a light-emitting unit is a light-emitting diode, there is a problem in that the light-emitting diode becomes more likely to flicker when the duty for switching a switch on and off is changed in order to stabilize the average value of the power consumed by the light-emitting diode.

Accordingly, an object of the present disclosure is to provide a drive device in which a light-emitting diode is not likely to flicker.

### Advantageous Effects of Disclosure

According to the present disclosure, a light-emitting diode is not likely to flicker.

### SUMMARY

A drive device according to one aspect of the present disclosure includes a drive unit, the drive unit switching a switch, one end of which is connected to one end of a battery, on and off in an alternating manner to drive a light-emitting diode disposed in a current path of current flowing from another end of the switch, and the drive device further including: a voltage detection unit that detects a battery voltage value at the one end of the battery; a calculation unit that calculates a duty on the basis of a detection value detected by the voltage detection unit; and a changing unit that changes a duty of the switching of the switch on and off to the duty calculated by the calculation unit, wherein when the battery voltage value is a detection value detected by the voltage detection unit, the duty calculated by the calculation unit is a ratio of a target current value to the value of current flowing in the current path when the switch is on.

Note that the present disclosure can be realized not only as a drive device including such characteristic processing units, but also as a drive method that takes the characteristic processes as steps, a computer program that causes a computer to execute those steps, and so on. Additionally, the present disclosure can be realized as a semiconductor integrated circuit that implements some or all of the drive device, as a drive system that includes the drive device, and so on.

### BRIEF DESCRIPTION OF DRAWINGS

FIG. 1 is a block diagram illustrating the primary configuration of a power source system according to a first embodiment.

FIG. 2 is a flowchart illustrating a drive start process sequence.

FIG. 3 is a flowchart illustrating a duty change process sequence.

FIG. 4 is a flowchart illustrating a drive stop process sequence.

FIG. 5 is a graph illustrating an example of transitions in the value of voltage applied to a light emission circuit.

FIG. 6 is a graph illustrating an example of transitions in the value of voltage applied to a light emission circuit in a second embodiment.

FIG. 7 is a block diagram illustrating the primary configuration of a power source system according to a third embodiment.

FIG. 8 is a graph illustrating a relationship between duty and a detection value.

### DETAILED DESCRIPTION OF PREFERRED EMBODIMENTS

First, embodiments of the present disclosure will be described as examples. The embodiments described hereinafter may be at least partially combined as desired.

A drive device according to one aspect of the present disclosure includes a drive unit, the drive unit switching a switch, one end of which is connected to one end of a battery, on and off in an alternating manner to drive a light-emitting diode disposed in a current path of current flowing from another end of the switch, and the drive device further including: a voltage detection unit that detects a battery voltage value at the one end of the battery; a calculation unit that calculates a duty on the basis of a detection value detected by the voltage detection unit; and a changing unit that changes a duty of the switching of the switch on and off to the duty calculated by the calculation unit, wherein when the battery voltage value is a detection value detected by the voltage detection unit, the duty calculated by the calculation unit is a ratio of a target current value to the value of current flowing in the current path when the switch is on.

According to this aspect, the battery voltage value at one end of the battery is detected, a duty is calculated on the basis of the detected detection value, and the duty for switching the switch on and off is changed to the calculated duty. Here, the calculated duty is, when the battery voltage value is the detected detection value, the ratio of the target current value to the value of current flowing in the current path when the switch is on. Accordingly, the average value of the current flowing in the light-emitting diode stabilizes at the target current value regardless of the battery voltage value, and the light-emitting diode is less likely to flicker.

In a drive device according to an aspect of the present disclosure, assuming that the battery voltage value is a prescribed voltage value, the target current value is a value of current flowing in the current path when the switch is on; and the prescribed voltage value is less than or equal to a lower limit value of a fluctuation range of the battery voltage value.

According to this aspect, the prescribed voltage value is less than or equal to the lower limit value of the fluctuation range of the battery voltage value, and thus the average value of the current flowing in the current path can be adjusted to the target current value by changing the duty for switching the switch on and off.

A drive device according to an aspect of the present disclosure further includes a diode disposed in a second current path in which current flows from the other end of the switch, wherein the drive unit also drives a second light-emitting diode disposed in the second current path by carrying out the switching in an alternating manner; and a width of a voltage drop arising in one or more diodes disposed in the current path when current flows in the current path substantially matches a width of a voltage drop arising in a plurality of diodes disposed in the second current path when current flows in the second current path.

According to this aspect, the light-emitting diode disposed in the current path, as well as the second light-emitting diode disposed in the second current path, are driven by switching the switch on and off in an alternating manner. The width of the voltage drop arising in one or more diodes disposed in the current path when current flows in the current path substantially matches the width of the voltage drop arising in a plurality of diodes disposed in the second current path when current flows in the second current path. Accordingly, the average value of the current flowing in the second light-emitting diode disposed in the second current path also stabilizes regardless of the battery voltage value.

A drive device according to an aspect of the present disclosure further includes: a second diode disposed in a third current path in which current flows from the other end of the switch, wherein the drive unit also drives an incandescent light bulb disposed in the third current path by carrying out the switching in an alternating manner; and the second diode is used to stabilize a value of power consumed by the incandescent light bulb.

According to this aspect, both the light-emitting diode disposed in the current path and the incandescent light bulb disposed in the third current path are driven by switching the switch on and off in an alternating manner. The duty for switching the switch on and off is the above-described ratio, but disposing the second diode in the third current path makes it possible to realize a configuration in which the value of power consumed by the incandescent light bulb stabilizes at the target power value. In this case, the intensity of the light emitted by the incandescent light bulb stabilizes, and the incandescent light bulb is less likely to flicker.

### DETAILS OF EMBODIMENT OF PRESENT DISCLOSURE

A specific example of the drive device according to embodiments of the present disclosure will be described hereinafter with reference to the drawings. Note that the present disclosure is not intended to be limited to these examples, and is defined instead by the scope of the appended claims. All changes that fall within the same essential spirit as the scope of the claims are intended to be included therein as well.

### First Embodiment

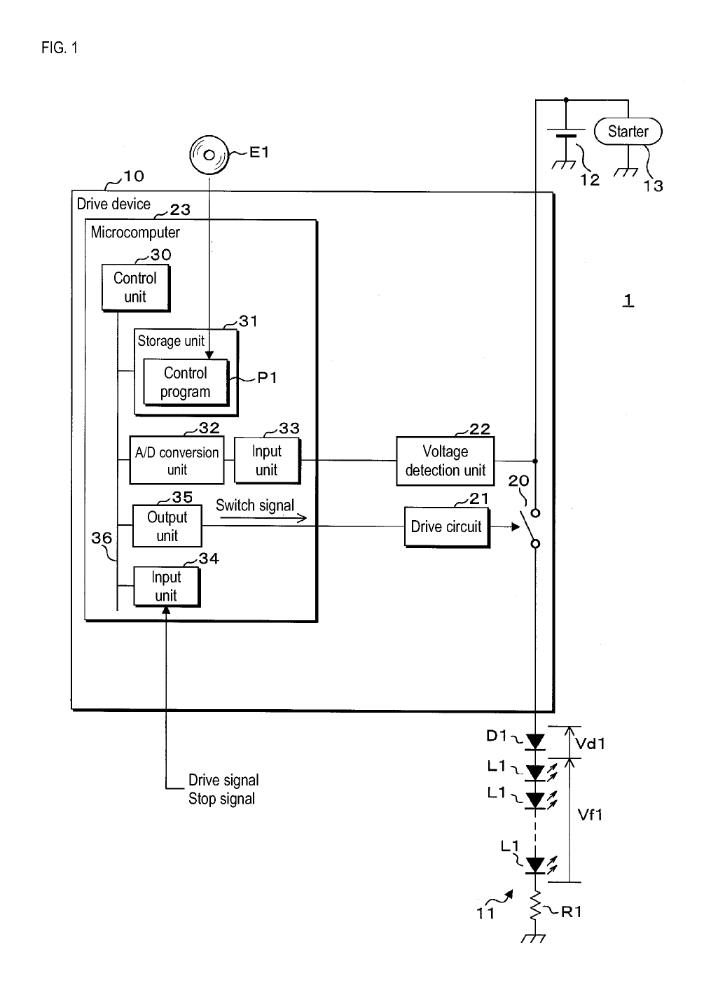

FIG. 1 is a block diagram illustrating the primary configuration of a power source system 1 according to a first embodiment. The power source system 1 is favorably installed in a vehicle, and includes a drive device 10, a light emission circuit 11, a battery 12, and a starter 13.

The drive device 10 is connected separately to one end of the light emission circuit 11 and a positive terminal of the battery 12. One end of the starter 13 is also connected to the positive terminal of the battery 12. Another end of the light emission circuit 11, a negative terminal of the battery 12, and another end of the starter 13 are grounded.

The light emission circuit 11 includes a diode D1, N (where N is a natural number) light-emitting diodes L1, L1, . . . , L1, and a resistor R1. These are connected in series within the light emission circuit 11. The diode D1 and the N light-emitting diodes L1, L1, . . . , L1 have the same forward directions. In the diode D1 and the N light-emitting diodes L1, L1, . . . , L1, the anode is connected to the drive device 10 side, and the cathode is connected to the grounded side.

It should be noted that in the light emission circuit 11, the order in which the diode D1, the N light-emitting diodes L1, L1, . . . , L1, and the resistor R1 are connected from the drive device 10 side is not limited to the order illustrated in FIG. 1. It is sufficient for the diode D1, the N light-emitting diodes L1, L1, . . . , L1, and the resistor R1 to be connected in series in the light emission circuit 11.

In the power source system 1, current flows from the positive terminal of the battery 12 and through the drive device 10 and the light emission circuit 11 in that order. When current flows in the light emission circuit 11, the N light-emitting diodes L1, L1, . . . , L1 in the light emission circuit 11 emit light. The light emitted by the N light-emitting diodes L1, L1, . . . , L1 gains intensity as the average value of the current flowing in the light emission circuit 11 increases. Here, the average value of the current is a value averaged over a finite constant period, e.g., over one cycle of a switch signal, which will be described later.

The battery 12 supplies power not only to the light emission circuit 11, but also to the starter 13. The starter 13 is a motor for starting an engine (not shown). When the battery 12 supplies power, current flows in the battery 12 through an internal resistor (not shown), and the voltage drops in the internal resistor. The width of the voltage drop arising in the internal resistor is greater the greater the value of the current flowing through the internal resistor is. The battery 12 outputs voltage through the internal resistor. The value of the voltage output by the battery 12, i.e., the voltage value at the positive terminal of the battery 12, differs depending on whether or not the starter 13 is operating. When the starter 13 is operating, a high current flows through the internal resistor of the battery 12, and thus the value of the voltage output from the battery 12 is low. When the starter 13 is stopped, a low current flows through the internal resistor of the battery 12, and thus the value of the voltage output from the battery 12 is high.

When the battery 12 supplies power to the light emission circuit 11, the width of the voltage drop arising in the internal resistor of the battery 12 is sufficiently low. As such, the value of the voltage output by the battery 12 experiences almost no fluctuation depending on whether or not the battery 12 is supplying power to the light emission circuit 11.

The value of the voltage output by the battery 12 fluctuates each time the starter 13 operates and each time the starter 13 stops operating. In the following, an upper limit value of a fluctuation range pertaining to the value of the voltage output by the battery 12 will be represented by Vt, and a lower limit value of the fluctuation range will be represented by Vb (<Vt). When the starter 13 is operating, the value of the voltage output by the battery 12 is the lower limit value Vb, whereas when the starter 13 is stopped, the value of the voltage output by the battery 12 substantially matches the upper limit value Vt.

Drive signals that instruct driving of the N light-emitting diodes L1, L1, . . . , L1, and stop signals that instruct the driving of the N light-emitting diodes L1, L1, . . . , L1 to be stopped, are input to the drive device 10.

When a drive signal is input, the drive device 10 intermittently connects the positive terminal of the battery 12 with the one end of the light emission circuit 11. As a result, current is supplied from the battery 12 to the light emission circuit 11, and the N light-emitting diodes L1, L1, . . . , L1 emit light.

When a stop signal is input, the drive device 10 cuts the connection between the battery 12 and the light emission circuit 11. As a result, the supply of current from the battery 12 to the light emission circuit 11 is stopped, and the N light-emitting diodes L1, L1, . . . , L1 stop emitting light.

The drive device 10 includes a switch 20, a drive circuit 21, a voltage detection unit 22, and a microcomputer 23. One end of the switch 20 and the voltage detection unit 22 are connected to the positive terminal of the battery 12. The other end of the switch 20 is connected to one end of the light emission circuit 11. Both the drive circuit 21 and the voltage detection unit 22 are also connected to the microcomputer 23. The switch 20 is a field effect transistor (FET), a bipolar transistor, a relay contact point, or the like.

When the switch 20 is on, current flows from the positive terminal of the battery 12, to the switch 20, and then to the light emission circuit 11, in that order. The light emission circuit 11 is disposed in a current path of current flowing from the other end of the switch 20. When the switch 20 is off, no current flows from the positive terminal of the battery 12 to the light emission circuit 11.

The switch signal is input to the drive circuit 21 from the microcomputer 23. The switch signal includes a high-level voltage and a low-level voltage.

If, while the switch signal is being input from the microcomputer 23 to the drive circuit 21, the voltage of the switch signal switches from the low-level voltage to the high-level voltage, the drive circuit 21 switches the switch 20 from off to on. If the voltage of the switch signal switches from the high-level voltage to the low-level voltage in the same situation, the drive circuit 21 switches the switch 20 from on to off. As such, the switch 20 is on while the switch signal is at the high-level voltage, and the switch 20 is off while the switch signal is at the low-level voltage. The drive circuit 21 keeps the switch 20 off while no switch signal is being input to the drive circuit 21 from the microcomputer 23.

The voltage detection unit 22 detects the value of the voltage output by the battery 12, and outputs, to the microcomputer 23, analog detection value information expressing a detection value Vs that has been detected.

The microcomputer 23 starts outputting the switch signal to the drive circuit 21 upon a drive signal being input to an input unit 34, and stops outputting the switch signal upon a stop signal being input to the input unit 34. The microcomputer 23 adjusts the duty of the switch signal output to the drive circuit 21 on the basis of the detection value Vs, which expresses the detection value information input from the voltage detection unit 22.

In the switch signal, the switch from the low-level voltage to the high-level voltage or the switch from the high-level voltage to the low-level voltage occurs cyclically. The period of the high-level voltage in a single cycle of the switch signal is referred to as a “high-level period”, and the duty is the ratio of the high-level period to a single cycle of the switch signal. The duty is expressed as a percentage (%). The duty is greater than or equal to 0% and less than or equal to 100%. A duty of 0% indicates that the switch signal is at the low-level voltage for the entire cycle, whereas a duty of 100% indicates that the switch signal is at the high-level voltage for the entire cycle.

The microcomputer 23 includes a control unit 30, a storage unit 31, an A(Analog)/D(Digital) conversion unit 32, input units 33 and 34, and an output unit 35. The control unit 30, the storage unit 31, the A/D conversion unit 32, the input unit 34, and the output unit 35 are connected to a bus 36. In addition to the bus 36, the A/D conversion unit 32 is connected to the input unit 33, and the input unit 33 in turn is connected to the voltage detection unit 22. In addition to the bus 36, the output unit 35 is connected to the drive circuit 21.

The analog detection value information from the voltage detection unit 22 is input to the input unit 33. When the analog detection value information has been input from the voltage detection unit 22, the input unit 33 outputs the input analog detection value information to the A/D conversion unit 32. The A/D conversion unit 32 converts the analog detection value information input from the input unit 33 into digital detection value information. The digital detection value information resulting from the conversion by the A/D conversion unit 32 is obtained by the control unit 30. The detection value Vs expressed by the detection value information obtained from the A/D conversion unit 32 by the control unit 30 matches or substantially matches the value of the voltage output by the battery 12 at the point in time when the detection value information is obtained.

The drive signal and the stop signal are input to the input unit 34. When the drive signal or the stop signal is input to the input unit 34, the input unit 34 notifies the control unit 30 to that effect.

The output unit 35 outputs the switch signal to the drive circuit 21, changes the duty of the switch signal, and stops the output of the switch signal in response to instructions from the control unit 30.

The storage unit 31 is non-volatile memory. A control program P1 is stored in the storage unit 31.

The control unit 30 includes a central processing unit (CPU) (not illustrated). By executing the control program P1 stored in the storage unit 31, the CPU of the control unit 30 executes a drive start process, a duty change process, and a drive stop process. The drive start process is a process of starting the driving of the N light-emitting diodes L1, L1, . . . , L1. The duty change process is a process of changing the duty of the switch signal output from the output unit 35 to the drive circuit 21. The drive stop process is a process of stopping the driving of the N light-emitting diodes L1, L1, . . . , L1. The control program P1 is a computer program for causing the CPU of the control unit 30 to execute the drive start process, the duty change process, and the drive stop process.

Note that the control program P1 may be stored in a storage medium E1 so as to be readable by a computer. In this case, the control program P1 read out from the storage medium E1 by a readout device (not shown) is stored in the storage unit 31. The storage medium E1 is an optical disk, a flexible disk, a magnetic disk, a magneto-optical disk, semiconductor memory, or the like. The optical disk is a CD (Compact Disc)-ROM (Read Only Memory), DVD (Digital Versatile Disc)-ROM, a BD (Blu-ray (registered trademark) Disc), or the like. The magnetic disk is a hard disk, for example. Additionally, the control program P1 may be downloaded from an external device (not shown) connected to a communication network (not shown), and the downloaded control program P1 may be stored in the storage unit 31.

Flag values are also stored in the storage unit 31. A flag has a value of either 0 or 1. A flag having a value of 0 indicates that the driving of the N light-emitting diodes L1, L1, . . . , L1 is stopped. A flag having a value of 1 indicates that the N light-emitting diodes L1, L1, . . . , L1 are being driven. The values of the flags are set by the control unit 30.

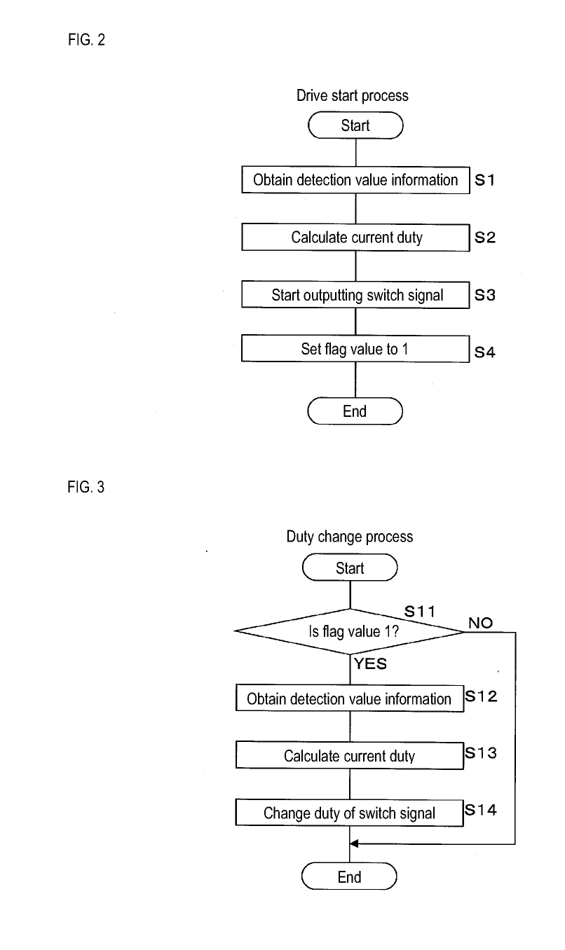

FIG. 2 is a flowchart illustrating the drive start process sequence. The control unit 30 executes the drive start process when a drive signal is input to the input unit 34. In the drive start process, first, the control unit 30 obtains the digital detection value information from the A/D conversion unit 32 (step S1), and calculates a current duty (step S2). Like the duty of the switch signal, the current duty is expressed as a percentage (%).

The following Expression 1 is stored in the storage unit 31.

Ti=100·(Vc−Vd1−Vf1)/(Vs−Vd1−Vf1) (1) Vc=Vb

Expression 1 is an expression for calculating a current duty Ti. The “·” represents multiplication. Vc is a prescribed voltage value. The prescribed voltage value Vc is set to the lower limit value Vb of the fluctuation range of the value of the voltage output by the battery 12. As described earlier, the detection value Vs is a detection value expressed by the detection value information obtained from the A/D conversion unit 32 by the control unit 30. Additionally, as illustrated in FIG. 1, a voltage value Vd1 represents the width of a voltage drop arising in the diode D1 when current flows in the current path in which the light emission circuit 11 is disposed. A voltage value Vf1 represents the width of a voltage drop arising in the N light-emitting diodes L1, L1, . . . , L1 when current flows in the current path. The lower limit value Vb is a constant value.

Expression 1 can be rewritten as the following Expression 2 by dividing both the numerator and denominator in the right side of Expression 1 by a resistance value r1 of the resistor R1.

Ti=100·((Vc−Vd1−Vf1)/r1)/((Vs−Vd1−Vf1)/r1) (2)

Assuming that the value of the voltage output by the battery 12 is the prescribed voltage value Vc (=Vb), (Vc−Vd1−Vf1)/r1 represents, when the switch 20 is on, a current value Ic1 flowing in the current path in which the light emission circuit 11 is disposed.

Furthermore, assuming that the value of the voltage output by the battery 12 is the detection value Vs expressed by the detection value information obtained from the A/D conversion unit 32 by the control unit 30, (Vs−Vd1−Vf1)/r1 represents, when the switch 20 is on, a current value Is1 flowing in the current path in which the light emission circuit 11 is disposed.

The current duty Ti is the ratio of the current value Ic1 to the current value Is1. The current value Ic1 corresponds to a target current value.

In step S2, the control unit 30 calculates the current duty Ti by substituting, into Expression 1, the detection value Vs expressed by the detection value information obtained in step S1.

After executing step S2, the control unit 30 makes an instruction to the output unit 35 to start the output of the switch signal (step S3). Here, the duty of the switch signal output by the output unit 35 is set to the current duty calculated in step S2. As described above, the drive circuit 21 switches the switch 20 on when the voltage of the switch signal switches from the low-level voltage to the high-level voltage, and switches the switch 20 off when the voltage of the switch signal switches from the high-level voltage to the low-level voltage. The drive circuit 21 repeatedly switches the switch 20 on and off in an alternating manner in accordance with the voltage of the switch signal. As a result, current is supplied to the N light-emitting diodes L1, L1, . . . , L1 of the light emission circuit 11, and the N light-emitting diodes L1, L1, . . . , L1 emit light.

As described above, the N light-emitting diodes L1, L1, . . . , L1 are driven by the drive circuit 21 repeatedly switching the switch 20 on and off in an alternating manner. The drive circuit 21 therefore functions as a drive unit. The duty of the switch signal corresponds to the duty at which the switch 20 is turned on and off.

The average value of the current flowing in the current path in which the light emission circuit 11 is disposed is a value obtained by dividing the product of the current value Is1 and the current duty Ti calculated in step S2 by 100, i.e., the current value Ic1. The intensity of the light emitted by the light-emitting diodes L1 is an intensity corresponding to the current value Ic1.

After executing step S3, the control unit 30 sets the value of the flag to 1 (step S4), and ends the drive start process.

FIG. 3 is a flowchart illustrating the duty change process sequence. The control unit 30 executes the duty change process periodically. The control unit 30 first determines whether or not the value of the flag is 1 (step S11). As described earlier, a flag having a value of 1 indicates that the N light-emitting diodes L1, L1, . . . , L1 are being driven, whereas a flag having a value of 0 indicates that the driving of the N light-emitting diodes L1, L1, . . . , L1 is stopped. When the value of the flag is 1, the output unit 35 outputs the switch signal to the drive circuit 21.

If it is determined that the value of the flag is not 1, i.e., the value of the flag is 0 (S11: NO), the control unit 30 ends the duty change process.

If it is determined that the value of the flag is 1 (S11: YES), the control unit 30 obtains the detection value information from the A/D conversion unit 32 (step S12), and calculates the current duty by substituting the detection value Vs expressed by the obtained detection value information into Expression 1 (step S13). Then, the control unit 30 changes the duty of the switch signal output by the output unit 35 to the current duty calculated in step S13 (step S14), and ends the duty change process. The control unit 30 therefore functions as a calculation unit and a changing unit.

As described earlier, the control unit 30 executes the duty change process periodically. Therefore, the duty of the switch signal is changed so that each time the value of the voltage output by the battery 12 fluctuates, the average value of the current flowing in the current path in which the light emission circuit 11 is disposed takes on the current value Ic1. As a result, the average value of the current flowing in the N light-emitting diodes L1, L1, . . . , L1 stabilizes at the current value Ic1 regardless of the value of the voltage output by the battery 12. The intensity of the light emitted by the N light-emitting diodes L1, L1, . . . , L1 therefore stabilizes, and the N light-emitting diodes L1, L1, . . . , L1 are less likely to flicker.

A configuration in which a DC-DC converter is connected between the positive terminal of the battery 12 and the end of the switch 20 on the battery 12 side is conceivable as a configuration that stabilizes the average value of the current flowing in the N light-emitting diodes L1, L1, . . . , L1 at the current value Ic1 regardless of the value of the voltage output by the battery 12. With this configuration, the DC-DC converter appropriately adjusts a step-up width or a step-down width to transform the voltage output by the battery 12 to a constant voltage, and outputs the transformed voltage toward the switch 20. Compared to this configuration, the drive device 10 does not require a DC-DC converter. The drive device 10 is therefore compact, and can be manufactured at low cost.

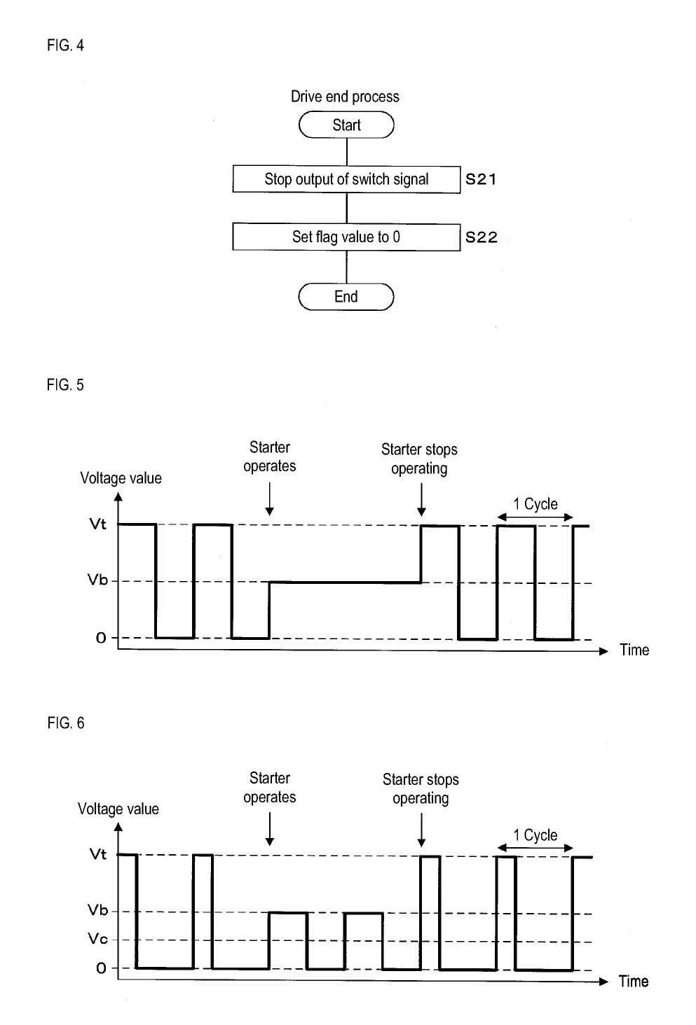

FIG. 4 is a flowchart illustrating the drive stop process sequence. The control unit 30 executes the drive stop process when the stop signal is input to the input unit 34. The control unit 30 first instructs the output unit 35 to stop the output of the switch signal (step S21). As described earlier, the drive circuit 21 keeps the switch 20 off while the output unit 35 is stopping the output of the switch signal. After executing step S21, the control unit 30 sets the value of the flag to 0 (step S22), and ends the drive stop process.

FIG. 5 is a graph illustrating an example of transitions in the value of the voltage applied to the light emission circuit 11. The vertical axis represents the voltage value, and the horizontal axis represents time. FIG. 5 illustrates transitions in the voltage value when the output unit 35 outputs the switch signal and the N light-emitting diodes L1, L1, . . . , L1 are being driven.

As illustrated in FIG. 5, the value of the voltage output by the battery 12 is the upper limit value Vt while the starter 13 is stopped. The duty of the switch signal is less than 100% while the starter 13 is stopped, and the drive circuit 21 repeatedly switches the switch 20 on and off in an alternating manner. The upper limit value Vt of the value of the voltage output by the battery 12 is applied to the light emission circuit 11 when the switch 20 is on, whereas the value of the voltage applied to the light emission circuit 11 is 0 V when the switch 20 is off. The average value of the voltage applied to the light emission circuit 11 is the prescribed voltage value Vc (=Vb), and the average value of the current flowing in the current path in which the light emission circuit 11 is disposed is the current value Ic1.

When the value of the voltage output by the battery 12 becomes the lower limit value Vb due to the starter 13 operating, the duty of the switch signal becomes 100%, and the switch 20 is kept on. The average value of the voltage applied to the light emission circuit 11 is the prescribed voltage value Vc (=Vb), and the average value of the current flowing in the current path in which the light emission circuit 11 is disposed is the current value Ic1.

As described above, the average value of the current flowing in the N light-emitting diodes L1, L1, . . . , L1 stabilizes at the current value Ic1 regardless of the value of the voltage output by the battery 12.

According to the drive device 10, the prescribed voltage value Vc is the lower limit value Vb of the fluctuation range of the value of the voltage output by the battery 12. Therefore, the average value of the current flowing in the current path in which the light emission circuit 11 is disposed can be adjusted to the current value Ic1 by changing the duty of the switch signal.

### Second Embodiment

In the first embodiment, the prescribed voltage value Vc is set to the lower limit value Vb of the fluctuation range of the value of the voltage output by the battery 12. However, the prescribed voltage value Vc is not limited to the lower limit value Vb, and may be less than or equal to the lower limit value Vb.

Hereinafter, points of the second embodiment that are different from the first embodiment will be described. Configurations aside from those described hereinafter are the same as in the first embodiment. As such, constituent elements that are the same as in the first embodiment will be given the same reference signs as in the first embodiment, and descriptions thereof will be omitted.

FIG. 6 is a graph illustrating an example of transitions in the value of the voltage applied to the light emission circuit 11 according to the second embodiment. The vertical axis represents the voltage value, and the horizontal axis represents time. Like FIG. 5, FIG. 6 illustrates transitions in the voltage value when the output unit 35 outputs the switch signal and the N light-emitting diodes L1, L1, . . . , L1 are being driven.

The second embodiment differs from the first embodiment in that the prescribed voltage value Vc is a voltage value that is less than the lower limit value Vb of the fluctuation range of the value of the voltage output by the battery 12.

In the second embodiment, the duty of the switch signal is less than 100% both while the starter 13 is stopped and while the starter 13 is operating, and the drive circuit 21 repeatedly switches the switch 20 on and off in an alternating manner. The duty of the switch signal is changed so that the average value of the voltage applied to the light emission circuit 11 becomes the prescribed voltage value Vc.

The lower limit value Vb of the fluctuation range of the value of the voltage output by the battery 12 is lower than the value of the voltage output by the battery 12 while the starter 13 is stopped, i.e., is lower than the upper limit value Vt of the fluctuation range of the value of the voltage output by the battery 12. Accordingly, the duty of the switch signal being output by the output unit 35 while the starter 13 is running, i.e., the percentage of one switch signal cycle occupied by a period in which the switch 20 is on, is higher than the duty of the switch signal being output by the output unit 35 while the starter 13 is stopped.

The drive device 10 according to the second embodiment configured as described above provides the same effects as those of the drive device 10 according to the first embodiment. Thus, according to the drive device 10 of the second embodiment as well, the average value of the voltage applied to the light emission circuit 11 is adjusted to the prescribed voltage value Vc, and the average value of the current flowing in the current path in which the light emission circuit 11 is disposed is adjusted to the current value Ic1, by changing the duty of the switch signal.

### Third Embodiment

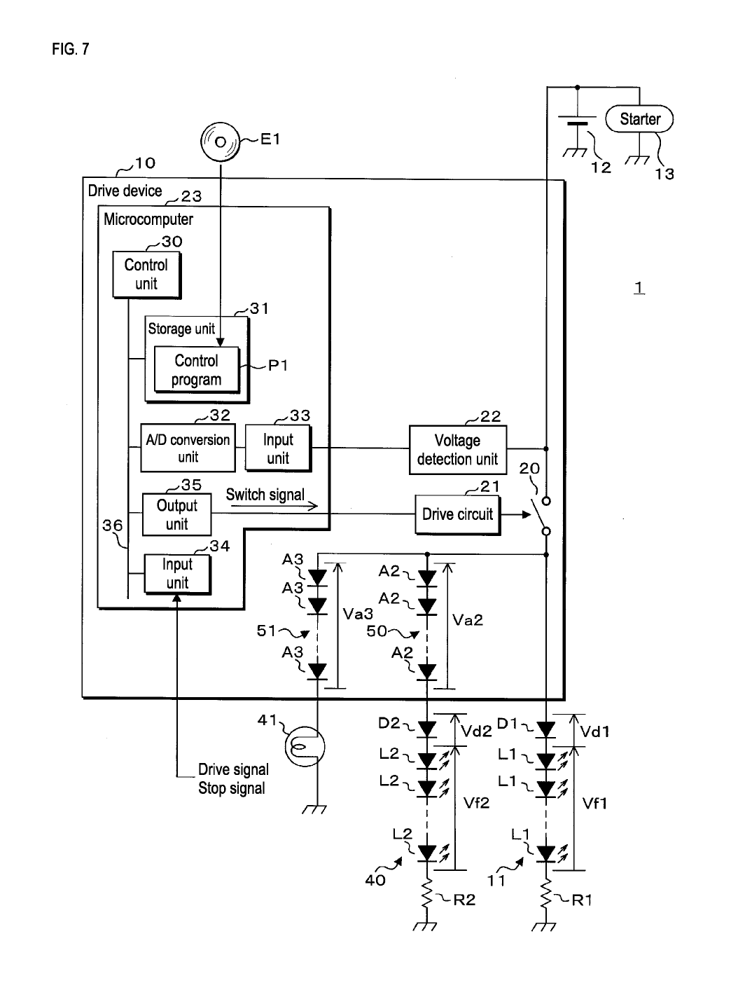

FIG. 7 is a block diagram illustrating the primary configuration of the power source system 1 according to a third embodiment.

Hereinafter, points of the third embodiment that are different from the first embodiment will be described. Configurations aside from those described hereinafter are the same as in the first embodiment. As such, constituent elements that are the same as in the first embodiment will be given the same reference signs as in the first embodiment, and descriptions thereof will be omitted.

The power source system 1 according to the third embodiment can also be favorably installed in a vehicle. The power source system 1 according to the third embodiment includes a light emission circuit 40 and an incandescent light bulb 41 in addition to the constituent elements of the power source system 1 according to the first embodiment. One end each of the light emission circuit 40 and the incandescent light bulb 41 is connected to the drive device 10. The other ends of the light emission circuit 40 and the incandescent light bulb 41 are grounded.

The light emission circuit 40 includes a diode D2, M (where M is a natural number) light-emitting diodes L2, L2, . . . , L2, and a resistor R2. These are connected in series within the light emission circuit 40. The diode D2 and the M light-emitting diodes L2, L2, . . . , L2 have the same forward directions. In the diode D2 and the M light-emitting diodes L2, L2, . . . , L2, the anode is connected to the drive device 10 side, and the cathode is connected to the grounded side.

It should be noted that in the light emission circuit 40, the order in which the diode D2, the M light-emitting diodes L2, L2, . . . , L2, and the resistor R2 are connected from the drive device 10 side is not limited to the order illustrated in FIG. 7. It is sufficient for the diode D2, the M light-emitting diodes L2, L2, . . . , L2, and the resistor R2 to be connected in series in the light emission circuit 40.

In the power source system 1 according to the third embodiment, current flows from the positive terminal of the battery 12, through the drive device 10, and to each of the light emission circuits 11 and 40 and the incandescent light bulb 41.

When current flows in the light emission circuit 40, the M light-emitting diodes L2, L2, . . . , L2 in the light emission circuit 40 emit light. The light emitted by the M light-emitting diodes L2, L2, . . . , L2 gains intensity as the average value of the current flowing in the light emission circuit 40 increases. Here, the average value of the current is a value averaged over a finite constant period, e.g., over one cycle of the switch signal.

The incandescent light bulb 41 emits light when current flows in the incandescent light bulb 41. The light emitted by the incandescent light bulb 41 gains intensity as the average value of the power consumed by the incandescent light bulb 41 increases. Here, the average value of the power is a value averaged over a finite constant period, e.g., over one cycle of the switch signal.

Like the first embodiment, in the third embodiment, the battery 12 supplies power to the starter 13 as well, and thus the value of the voltage output by the battery 12 fluctuates. When the battery 12 supplies power to the light emission circuits 11 and 40 and the incandescent light bulb 41, the width of the voltage drop arising in the internal resistor of the battery 12 is sufficiently low. As such, the value of the voltage output by the battery 12 experiences almost no fluctuation depending on whether or not the battery 12 is supplying power to the light emission circuits 11 and 40 and the incandescent light bulb 41.

As in the first embodiment, when the starter 13 is operating, the value of the voltage output by the battery 12 is the lower limit value Vb, whereas when the starter 13 is stopped, the value of the voltage output by the battery 12 substantially matches the upper limit value Vt.

In the third embodiment too, the drive signal and the stop signal are input to the drive device 10. In the third embodiment, the drive signal instructs the driving of the N light-emitting diodes L1, L1, . . . , L1, the M light-emitting diodes L2, L2, . . . , L2, and the incandescent light bulb 41. The stop signal instructs the driving of the N light-emitting diodes L1, L1, . . . , L1, the M light-emitting diodes L2, L2, . . . , L2, and the incandescent light bulb 41 to stop.

When a drive signal is input, the drive device 10 intermittently connects the positive terminal of the battery 12 with the one end of each of the light emission circuits 11 and 40 and the incandescent light bulb 41. As a result, current is supplied from the battery 12 to the light emission circuits 11 and 40 and the incandescent light bulb 41, and the N light-emitting diodes L1, L1, . . . , L1, the M light-emitting diodes L2, L2, . . . , L2, and the incandescent light bulb 41 emit light.

When the stop signal is input, the drive device 10 stops the supply of current from the battery 12 to the light emission circuits 11 and 40 and the incandescent light bulb 41. As a result, the N light-emitting diodes L1, L1, . . . , L1, the M light-emitting diodes L2, L2, . . . , L2, and the incandescent light bulb 41 stop emitting light.

The drive device 10 according to the third embodiment includes diode circuits 50 and 51 in addition to the constituent elements of the drive device 10 according to the first embodiment. One end each of the diode circuits 50 and 51 is connected to the light emission circuit 11-side end of the switch 20. The other end of the diode circuit 50 is connected to one end of the light emission circuit 40. The other end of the diode circuit 51 is connected to one end of the incandescent light bulb 41.

The diode circuit 50 includes J (where J is a natural number) internal diodes A2, A2, . . . , A2 provided within the drive device 10. These are connected in series within the diode circuit 50. The J internal diodes A2, A2, . . . , A2 all have the same forward direction. In the J internal diodes A2, A2, . . . , A2, the anode is connected to the switch 20 side, and the cathode is connected to the light emission circuit 40 side

Likewise, the diode circuit 51 includes K (where K is a natural number) internal diodes A3, A3, . . . , A3 provided within the drive device 10. These are connected in series within the diode circuit 51. The K internal diodes A3, A3, . . . , A3 all have the same forward direction. In the K internal diodes A3, A3, . . . , A3, the anode is connected to the switch 20 side, and the cathode is connected to the incandescent light bulb 41 side.

As in the first embodiment, by executing the control program P1 stored in the storage unit 31, the CPU of the control unit 30 in the microcomputer 23 executes a drive start process, a duty change process, and a drive stop process. The control unit 30 executes the drive start process when a drive signal is input to the input unit 34, and executes the drive stop process when a stop signal is input to the input unit 34. The control unit 30 executes the duty change process periodically.

In the third embodiment, the drive start process is a process of starting the driving of the N light-emitting diodes L1, L1, . . . , L1, the M light-emitting diodes L2, L2, . . . , L2, and the incandescent light bulb 41. The drive stop process is a process of stopping the driving of the N light-emitting diodes L1, L1, . . . , L1, the M light-emitting diodes L2, L2, . . . , L2, and the incandescent light bulb 41.

The details of the drive start process, the duty change process, and the drive stop process in the third embodiment are the same as in the first embodiment.

In the third embodiment, a flag having a value of 0 indicates that the driving of the N light-emitting diodes L1, L1, . . . , L1, the M light-emitting diodes L2, L2, . . . , L2, and the incandescent light bulb 41 is stopped. A flag having a value of 1 indicates that the N light-emitting diodes L1, L1, . . . , L1, the M light-emitting diodes L2, L2, . . . , L2, and the incandescent light bulb 41 are being driven.

When the drive start process has been started by the control unit 30, the switch signal is output from the output unit 35 to the drive circuit 21, and the drive circuit 21 repeatedly switches the switch 20 on and off in an alternating manner in accordance with the voltage of the switch signal output from the output unit 35. As a result, current flows from the light emission circuit 11-side end of the switch 20 through the light emission circuit 11, current flows from the light emission circuit 11-side end of the switch 20 through the diode circuit 50 and the light emission circuit 40, and current flows from the light emission circuit 11-side end of the switch 20 through the diode circuit 51 and the incandescent light bulb 41.

As described above, according to the power source system 1 of the third embodiment, three current paths are provided in which current flows from the light emission circuit 11-side end of the switch 20. The light emission circuit 11 is disposed in the first current path. The diode circuit 50 and the light emission circuit 40 are disposed in the second current path. The diode circuit 51 and the incandescent light bulb 41 are disposed in the third current path.

The current path in which the diode circuit 50 and the light emission circuit 40 are disposed corresponds to a second current path. The current path in which the diode circuit 51 and the incandescent light bulb 41 are disposed corresponds to a third current path. Each of the K internal diodes A3, A3, . . . , A3 functions as a second diode.

When current flows in the current path in which the light emission circuit 11 is disposed, the N light-emitting diodes L1, L1, . . . , L1 emit light. When current flows in the current path in which the light emission circuit 40 is disposed, the M light-emitting diodes L2, L2, . . . , L2 emit light. When current flows in the current path in which the incandescent light bulb 41 is disposed, the incandescent light bulb 41 emits light.

The N light-emitting diodes L1, L1, . . . , L1, the M light-emitting diodes L2, L2, . . . , L2, and the incandescent light bulb 41 are driven by the drive circuit 21 repeatedly switching the switch 20 on and off in an alternating manner. While the drive circuit 21 keeps the switch 20 off, no current is supplied to the N light-emitting diodes L1, L1, . . . , L1, the M light-emitting diodes L2, L2, . . . , L2, and the incandescent light bulb 41, and the driving thereof is stopped. The light-emitting diodes L2 function as second light-emitting diodes.

As described in the first embodiment, in the drive start process and the duty change process, the duty of the switch signal is set and changed using Expression 1. Accordingly, the duty of the switch signal is adjusted so that the value of the current flowing in the current path in which the light emission circuit 11 is disposed is the prescribed current value Ic1.

According to the power source system 1 in the third embodiment, the following Expression 3 holds true.

Va2+Vd2+Vf2=Vd1+Vf1 (3)

Here, a voltage value Va2 represents the width of a voltage drop arising in the J internal diodes A2, A2, . . . , A2 when current flows in the diode circuit 50. A voltage value Vd2 represents the width of a voltage drop arising the diode D2 when current flows in the light emission circuit 40. A voltage value Vf2 represents the width of a voltage drop arising in the M light-emitting diodes L2, L2, . . . , L2 when current flows in the light emission circuit 40.

As described in the first embodiment, the voltage value Vd1 represents the width of a voltage drop arising the diode D1 when current flows in the light emission circuit 11. A voltage value Vf1 represents the width of a voltage drop arising in the N light-emitting diodes L1, L1, . . . , L1 when current flows in the light emission circuit 11.

Accordingly, the left side of Expression 3 represents the width of a voltage drop arising in the J internal diodes A2, A2, . . . , A2, the diode D2, and the M light-emitting diodes L2, L2, . . . , L2 when current flows in the current path in which the diode circuit 50 and the light emission circuit 40 are disposed. The right side of Expression 3 represents the width of a voltage drop arising in the diode D1 and the N light-emitting diodes L1, L1, . . . , L1 when current flows in the current path in which the light emission circuit 11 is disposed.

Note that even if Expression 3 does not strictly hold true, it is sufficient for the sum of the voltage values Va2, Vd2, and Vf2 to substantially match the sum of the voltage values Vd1 and Vf1 within a range in which Expression 3 can be viewed as holding true. When a difference (an absolute value) between the sum of the voltage values Va2, Vd2, and Vf2 and the sum of the voltage values Vd1 and Vf1 is, for example, less than or equal to 0.2 V Expression 3 is considered to hold true, that is, the sum of the voltage values Va2, Vd2, and Vf2 is considered to substantially match the sum of the voltage values Vd1 and Vf1.

Using Expression 3, Expression 1 can be rewritten as the following Expression 4.

Ti=100·(Vc−Va2−Vd2−Vf2)/(Vs−Va2−Vd2−Vf2) (4)

Furthermore, Expression 4 can be rewritten as the following Expression 5 by dividing both the numerator and denominator in the right side of Expression 4 by a resistance value r2 of the resistor R2.

Ti=100·((Vc−Va2−Vd2−Vf2)/r2)/((Vs−Va2−Vd2−Vf2)/r2) (5)

Assuming that the value of the voltage output by the battery 12 is the prescribed voltage value Vc (=Vb), (Vc−Va2−Vd2−Vf2)/r2 is, when the switch 20 is on, a current value Ic2 flowing in the current path in which the diode circuit 50 and the light emission circuit 40 are disposed.

Furthermore, assuming that the value of the voltage output by the battery 12 is the detection value Vs expressed by the detection value information obtained from the A/D conversion unit 32 by the control unit 30, (Vs−Va2−Vd2−Vf2)/r2 is, when the switch 20 is on, a current value Is2 flowing in the current path in which the diode circuit 50 and the light emission circuit 40 are disposed.

Accordingly, the current duty Ti is the ratio of the current value Ic1 to the current value Is1, and the ratio of the current value Ic2 to the current value Is2. The value of the current flowing in the light emission circuit 11 is adjusted to the prescribed current value Ic2 by the control unit 30 executing the drive start process and the duty change process.

As described thus far, according to the third embodiment, the diode circuit 50, i.e., the J internal diodes A2, A2, . . . , A2, are provided. Accordingly, the width of the voltage drop arising all the diodes disposed in the current path of the current flowing from the light emission circuit 11-side end of the switch 20 to the light emission circuit 40 is adjusted to match or substantially match the width of the voltage drop arising in all the diodes disposed in the current path of the current flowing from the light emission circuit 11-side end of the switch 20 to the light emission circuit 11. This makes it possible to supply current to both the light emission circuits 11 and 40 in a stable manner. Additionally, the current value Ic2 can be set to a current value different from the current value Ic1 by adjusted in the resistance value r2 of the resistor R2.

According to the power source system 1 in the third embodiment, when the M light-emitting diodes L2, L2, . . . , L2 are being driven, the average value of the current flowing in the light emission circuit 40 stabilizes at the current value Ic2 regardless of the value of the voltage output by the battery 12. The intensity of the light emitted by the M light-emitting diodes L2, L2, . . . , L2 therefore stabilizes, and the M light-emitting diodes L2, L2, . . . , L2 are less likely to flicker.

The intensity of the light emitted by the incandescent light bulb 41 stabilizes when the average value of the power consumed by the incandescent light bulb 41 stabilizes. Accordingly, the intensity of the light emitted by the incandescent light bulb 41 stabilizes when the duty of the switch signal is adjusted to a power duty Tp calculated through the following Expression 6. Like the duty of the switch signal and the current duty, the power duty Tp is expressed as a percentage (%).

Tp=100·((Vc−Va3)²/(Vs−Va3)²) (6)

Here, a voltage value Va3 is the width of a voltage drop arising in the K internal diodes A3, A3, . . . , A3 when current flows in the incandescent light bulb 41.

Expression 6 can be rewritten as the following Expression 7 by dividing both the numerator and denominator in the right side of Expression 6 by a resistance value r3 of the incandescent light bulb 41.

Tp=100·((Vc−Va3)²/r3)/((Vs−Va3)²/r3) (7)

Assuming that the value of the voltage output by the battery 12 is the prescribed voltage value Vc (=Vb), (Vc−Va3)²/r3 represents a power value Pc consumed by the incandescent light bulb 41 when the switch 20 is on.

When the value of the voltage output by the battery 12 is the detection value Vs expressed by the detection value information obtained from the A/D conversion unit 32 by the control unit 30, (Vs−Va3)²/r3 represents a power value Ps consumed by the incandescent light bulb 41 when the switch 20 is on. As described earlier, the detection value Vs is a value within the fluctuation range of the value of the voltage output by the battery 12.

The power duty Tp is calculated by dividing the power value Pc by the power value Ps.

If the duty of the switch signal is adjusted to the power duty Tp calculated using Expression 6 in the drive start process and the duty change process, the average value of the power consumed by the incandescent light bulb 41 is a value obtained by dividing the product of the power value Ps and the power duty Tp by 100, i.e., the power value Pc.

Accordingly, when the duty of the switch signal is adjusted to the power duty Tp calculated in Expression 6 in the drive start process and the duty change process, the average value of the power consumed by the incandescent light bulb 41 stabilizes at the power value Pc regardless of the value of the voltage output by the battery 12. When the average value of the power consumed by the incandescent light bulb 41 is stable, the intensity of the light emitted by the incandescent light bulb 41 stabilizes, and the incandescent light bulb 41 is less likely to flicker.

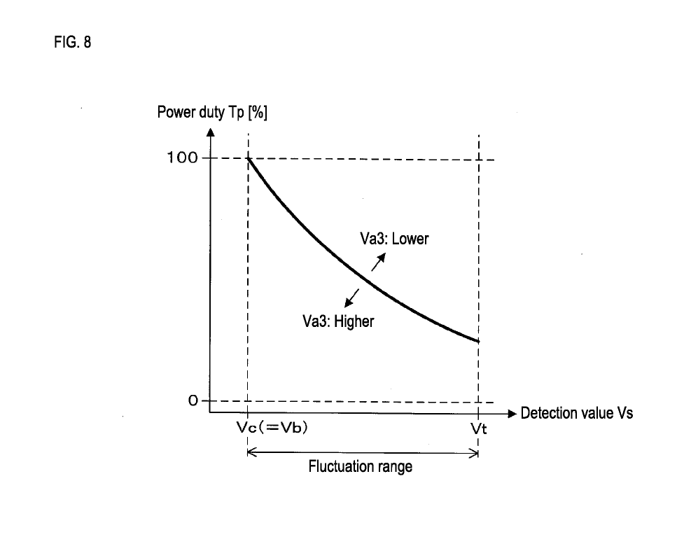

FIG. 8 is a graph illustrating a relationship between the power duty Tp and the detection value Vs. When the detection value Vs is the prescribed voltage value Vc (=Vb), the power duty Tp expressed by Expression 7 is 100%. The power duty Tp drops as the detection value Vs rises from the prescribed voltage value Vc (=Vb). The graph of the power duty Tp in which the horizontal axis represents the detection value Vs is a graph that protrudes downward.

As described earlier, a voltage value Va3 expresses a width of a voltage drop arising in the K internal diodes A3, A3, . . . , A3 when current flows in the current path in which the incandescent light bulb 41 is disposed. Assuming a constant detection value Vs in the fluctuation range of the value of the voltage output by the battery 12, the power duty Tp rises as the voltage value Va3 drops, and the power duty Tp drops as the voltage value Va3 rises.

The graph of the current duty Ti in which the horizontal axis represents the detection value Vs is, like the graph of the power duty Tp, a graph that protrudes downward. In the third embodiment, the graph of the current duty Ti matches or substantially matches the graph of the power duty Tp when the detection value Vs is a value within the fluctuation range of the value of the voltage output by the battery 12. At any detection value Vs within the fluctuation range, when a difference (an absolute value) between the power duty Tp and the current duty Ti is, for example, less than or equal to 2%, the graph of the current duty Ti can be considered to substantially match the graph of the power duty Tp.

Like the first embodiment, the duty of the switch signal is adjusted to the current duty calculated by the control unit 30 in the third embodiment as well. However, by providing the diode circuit 51, i.e., the K internal diodes A3, A3, . . . , A3, the graph of the power duty Tp can be caused to match or substantially match the graph of the current duty Ti, which makes it possible to realize a configuration in which the value of the power consumed by the incandescent light bulb 41 stabilizes at the power value Pc. According to the third embodiment, the value of the power consumed by the incandescent light bulb 41 is stable, and thus the intensity of the light emitted by the incandescent light bulb 41 stabilizes and the incandescent light bulb 41 is less likely to flicker.

As described above, the K internal diodes A3, A3, . . . , A3 are used to stabilize the value of the power consumed by the incandescent light bulb 41.

With the drive device 10 according to the third embodiment, the duty of the switch signal is adjusted in the same manner as in the first embodiment, and thus the drive device 10 according to the third embodiment achieves the same effects as those achieved by the drive device 10 according to the first embodiment.

In the third embodiment, the prescribed voltage value Vc is not limited to the lower limit value Vb of the fluctuation range of the value of the voltage output by the battery 12, and may be any value less than or equal to lower limit value Vb. Accordingly, the prescribed voltage value Vc may be a voltage value less than the lower limit value Vb, as in the second embodiment. Even in this case, the drive device 10 achieves the same effects as those described above. Additionally, the light emission circuit 40 need not include the diode D2, and may be constituted by the M light-emitting diodes L2, L2, . . . , L2 and the resistor R2, for example. In this case, the voltage value Vd2 is treated as 0 V.

In the first to third embodiments, the load that causes the value of the voltage output by the battery 12 to fluctuate is not limited to the starter 13, and may be any load to which a comparatively large amount of current is supplied. Furthermore, the number of loads to which power is directly supplied from the battery 12 is not limited to one, and may be two or more. In this case, the value of the voltage output by the battery 12 is the lower limit value Vb when all of the loads to which power is directly supplied from the battery 12 are operating, and is the upper limit value Vt when all of the loads to which power is directly supplied from the battery 12 are stopped.

Furthermore, the light emission circuit 11 need not include the diode D1, and may be constituted by the N light-emitting diodes L1, L1, . . . , L1 and the resistor R1, for example. In this case, the voltage value Vd1 is treated as 0V.

The first to third embodiments disclosed here are intended to be in all ways exemplary and in no ways limiting. The scope of the present disclosure is defined not by the foregoing descriptions but by the scope of the claims, and is intended to include all changes equivalent in meaning to and falling within the scope of the claims.

### FIG. 1, 7

10 DRIVE DEVICE
23 MICROCOMPUTER
30 CONTROL UNIT
31 STORAGE UNIT
P1 CONTROL PROGRAM
32 A/D CONVERSION UNIT
33 INPUT UNIT
35 OUTPUT UNIT
34 INPUT UNIT
[symbol] SWITCH SIGNAL
22 VOLTAGE DETECTION UNIT
21 DRIVE CIRCUIT
13 STARTER
[symbol] DRIVE SIGNAL
[symbol] STOP SIGNAL

### FIG. 2

[symbol] DRIVE START PROCESS
[symbol] START
S1 OBTAIN DETECTION VALUE INFORMATION
S2 CALCULATE CURRENT DUTY
S3 START OUTPUTTING SWITCH SIGNAL
S4 SET FLAG VALUE TO 1
[symbol] END

### FIG. 3

[symbol] DUTY CHANGE PROCESS
[symbol] START
S11 IS FLAG VALUE 1?
S12 OBTAIN DETECTION VALUE INFORMATION
S13 CALCULATE CURRENT DUTY
S14 CHANGE DUTY OF SWITCH SIGNAL
[symbol] END

### FIG. 4

[symbol] DRIVE END PROCESS
[symbol] START
S21 STOP OUTPUT OF SWITCH SIGNAL
S22 SET FLAG VALUE TO 0
[symbol] END

### FIG. 5, 6

[symbol] VOLTAGE VALUE
[symbol] STARTER OPERATES
[symbol] STARTER STOPS OPERATING
[symbol] CYCLE
[symbol] TIME

### FIG. 8

[symbol] POWER DUTY
[symbol] LOWER
[symbol] HIGHER
[symbol] FLUCTUATION RANGE
[symbol] DETECTION VALUE

1. A drive device comprising a drive unit, the drive unit switching a switch, one end of which is connected to one end of a battery, on and off in an alternating manner to drive a light-emitting diode disposed in a current path of current flowing from another end of the switch, the device further comprising:
a voltage detection unit that detects a battery voltage value at the one end of the battery;
a calculation unit that calculates a duty on the basis of a detection value detected by the voltage detection unit; and
a changing unit that changes a duty of the switching of the switch on and off to the duty calculated by the calculation unit,
wherein when the battery voltage value is a detection value detected by the voltage detection unit, the duty calculated by the calculation unit is a ratio of a target current value to the value of current flowing in the current path when the switch is on.

2. The drive device according to claim 1,
wherein assuming that the battery voltage value is a prescribed voltage value, the target current value is a value of current flowing in the current path when the switch is on; and
the prescribed voltage value is less than or equal to a lower limit value of a fluctuation range of the battery voltage value.

3. The drive device according to claim 1, further comprising:
a diode disposed in a second current path in which current flows from the other end of the switch,
wherein the drive unit also drives a second light-emitting diode disposed in the second current path by carrying out the switching in an alternating manner; and
a width of a voltage drop arising in one or more diodes disposed in the current path when current flows in the current path substantially matches a width of a voltage drop arising in a plurality of diodes disposed in the second current path when current flows in the second current path.

4. The drive device according to claim 1, further comprising:
a second diode disposed in a third current path in which current flows from the other end of the switch,
wherein the drive unit also drives an incandescent light bulb disposed in the third current path by carrying out the switching in an alternating manner; and
the second diode is used to stabilize a value of power consumed by the incandescent light bulb.

5. The drive device according to claim 2, further comprising:
a diode disposed in a second current path in which current flows from the other end of the switch,
wherein the drive unit also drives a second light-emitting diode disposed in the second current path by carrying out the switching in an alternating manner; and
a width of a voltage drop arising in one or more diodes disposed in the current path when current flows in the current path substantially matches a width of a voltage drop arising in a plurality of diodes disposed in the second current path when current flows in the second current path.

6. The drive device according to claim 2, further comprising:
a second diode disposed in a third current path in which current flows from the other end of the switch,
wherein the drive unit also drives an incandescent light bulb disposed in the third current path by carrying out the switching in an alternating manner; and
the second diode is used to stabilize a value of power consumed by the incandescent light bulb.

7. The drive device according to claim 3, further comprising:
a second diode disposed in a third current path in which current flows from the other end of the switch,
wherein the drive unit also drives an incandescent light bulb disposed in the third current path by carrying out the switching in an alternating manner; and
the second diode is used to stabilize a value of power consumed by the incandescent light bulb.
